(19) United States
(12) Patent Application Publication
(10) Pub. No.: US 2010/0044939 A1
(43) Pub. Date: Feb. 25, 2010

(54) Minimal to non-bulging urethane compression springs

(76) Inventor: Myron Stuart Hurwitz, Annandale, VA (US)

Correspondence Address: MYRON STUART HURWITZ, ARCHITECT, 4420 FOREST GLEN COURT, ANNANDALE, VA, 22003, US

(21) Appl. No.: 12/461,564

(22) Filed: Aug. 17, 2009

Related U.S. Application Data
(60) Provisional application No. 61/136,236, filed on Aug. 20, 2008.

(51) Int. Cl. F16F 1/36

(52) U.S. Cl. 267/153

(57) ABSTRACT

Urethane compression springs are designed to complement steel wire compression springs where such conditions as confined space, corrosion, vibration and magnetism prevent the use of conventional steel compression springs. Urethane spring material is a polyether-elastomer that reacts similarly to an incompressible fluid. As such, urethane springs bulge when compressed, requiring additional counteractive design remedies. The embodiments of this invention eliminate or minimize that bulging condition and counteractive remedies by having indentations in surfaces of the urethane spring.

This application claims the benefit of U.S. Provisional Application Ser. No. 61/136.236, filed Aug. 20, 2008, which is hereby incorporated by reference herein.

### BACKGROUND OF INVENTION

1. Field of Invention

This invention relates to the improvement of urethane compression springs, which universal shape is that of a smooth pipe-type rod. As the generic urethane rod is compressed, the rod bulges. Recognizing that pervasive reality, this invention minimizes or eliminates that compressive bulging distortion.

2. Status of Prior Art

While seemingly incongruous the spring industry, which typically produces a wide variety and assortment of compression and tension springs in steel (and other metal alloys), surprisingly urethane compression springs are commonly produced as well.

Urethane is a polyether-elastomer that was discovered during the 2^{nd} World War as a substitute for rubber. In many respects urethane has proven to be superior to natural rubber. As such, a significantly unusual function of urethane in the spring industry is its production and use as a compression spring. These urethane springs are designed to compliment steel wire compression spring applications, where corrosion, vibration and magnetism prevent the use of a conventional steel compression spring. Typical applications include: vibration dampening, corrosive environments, high loads in confined spaces, cycle and static loading; and, magnetic environments.

As compared to conventional steel springs, the advantages of urethane springs include the following:
High load-carrying capability
High dielectric strength and non-magnetic
Protection against marring/galling
Longer life
Abrasion resistance
Oil and solvent resistance
Low noise
Vibration damping and shock absorbency
100% load-bearing surface
Bondable to mating parts
Effectiveness between 30° F and 180°

The universal shape and form of a urethane compression spring consists of a pipe-type rod, having a smooth exterior surface as well as a smooth surface bore. The outside diameter and thickness of the rod's wall and the inside rod's bore diameter are produced in innumerable stock sizes and lengths. The urethane rods are also typically produced in four or more degrees of hardness (durometers), for example: 60A, 80A, 90A, and, 95A.

As typically explained in manufactures' literature, “ . . . urethane spring material is a polyether-elastomer that reacts similarly to an incompressible fluid. The volume of the material moved by compression is displaced laterally in the form of bulging sides. An approximation to the change in diameter of standard cylindrical urethane springs can be made by the inches of compression. The recommended maximum free (unloaded) length is 2.5 times the spring's outside diameter, although springs may be stacked with guide rods and washer-shaped spacers.”

The fact that urethane bulges when it is compressed, requires that the circular space or cavity that it functions in has to be larger in diameter than the urethane spring at rest. Aside from this looseness of the spring at rest being a possible disadvantage, the added size of the spring space or cavity as it may relate to other contiguous parts of an assembly, would likely be an additional disadvantage.

### SUMMARY OF INVENTION

This invention provides the novel means to minimize or eliminate the disadvantageous bulging that results when urethane springs are compressed. An additional inherent functional advantage of the invention would be an increase in the spring-like elasticity of urethane compression springs.

Instead of an industry standard urethane compression spring, having a smooth outside surface and bore's inside surface, the invention's urethane compression spring is significantly different. The outside rod's surface and inside bore's surface has a series of equally spaced concentric indented circles. The depth, width and centerline spacing of the indented circles is based on specific technical and design considerations.

Aside from concentric indented circles the indentations could instead be a continuous spiral indentation, simulating a coil spring for the outside rod and inside bore surfaces. As with the concentric indented circles, the width, depth and angle of the continuous spiral indentation for the outside rod and bore surfaces would again be determined by technical and design considerations.

These urethane springs can be used in the bearing assembly and/or wheel assembly disclosed in U.S. Pat. Nos. 6,637,827; 6,848,750; and, 7,108,33; the content of which is hereby incorporated by reference into this specification.

### BRIEF DESCRIPTION OF THE DRAWINGS

FIG. 1 is an isometric view of a typical bearing industry, urethane compression spring. The standard shape is that of a pipe-type rod with a smooth exterior surface and smooth interior bore surface.

FIG. 2 is a comparative isometric view of a urethane compression spring in accordance with the invention, wherein there are concentric indented circles on both the outside surface and inside bore's surface.

FIG. 3 is an industry standard cross section detail of a recommended method of minimizing the problem of bulging, which results when urethane springs are compressed. The exampled solution is to stack on a guide pin, short sections of urethane springs separated by stacking washers. This recommended procedure minimizes the negative effect of excessive bulging. Two stacking examples are shown using two different types of stacking washers.

FIG. 4 is a cross section view of a compressed urethane spring in accordance with an embodiment of the invention, wherein the length of the spring is equal in length to the two stacked prior art springs illustrated in FIG. 3. As comparatively shown, due to the concentric indented circles of the embodiment (on the exterior surface and interior bore's surface), bulging has been eliminated (as indicated) or substantially minimized.

### DEFINITIONS OF ALL REFERANCE NUMERALS INDICATED IN DRAWINGS

1. Smooth exterior surface of a urethane spring in a state of non-compression.
2. Smooth bore's surface of a urethane spring in a state of non-compression.
3. One of duplicate concentric indented circles equally spaced on the exterior surface of the inventive urethane spring in a state of non-compression.
4. One of duplicate concentric indented circles equally spaced within the bore's surface of the inventive urethane spring in a state of non-compression.
5. Bore of a urethane spring in a state of non-compression.
6. Prior Art Section of a urethane spring in a compressed state, typically resulting in a bulging condition.
7. Stacking Washer, flat.
8. Stacking Washer, dished.
9. Guide Pin or Rod.
10. Inventive urethane spring in a state of compression.
11. Indented circles equally spaced on the exterior surface of the inventive urethane spring in a state of compression.
12. Indented circles equally spaced on the interior bore's surface of the inventive spring in a state of compression.

### DETAILED DESCRIPTIONS OF THE INVENTION

Requiring an effective, realistic self-aligning spherical bearing for an inline skate wheel invention (as patented for example in U.S. Pat. No. 7,108,331), a novel spring activated self-aligning bearing was conceived using either a circular metal or urethane compression spring. While a metal compression spring within a confined space was a realistic consideration, a urethane compression spring was also considered to be a desirable choice for use in an inline skate wheel. However, one distinct problem of using a urethane compression spring became apparent—when urethane is compressed it expands. Resolving that problem led to this invention.

FIG. 1 is an isometric view of a typical non-compressed urethane spring that is in the basic shape of a pipe-type rod. Such urethane rods are commonly stocked throughout the bearing industry for special applications where steel-wire springs are not as well suited. These urethane compression springs are available in a wide range of: lengths; outside diameters; inside bore diameters; and, durometers. Uniformly, the stock urethane compression spring exterior surface 1 and inside bore surface 2 are perfectly smooth.

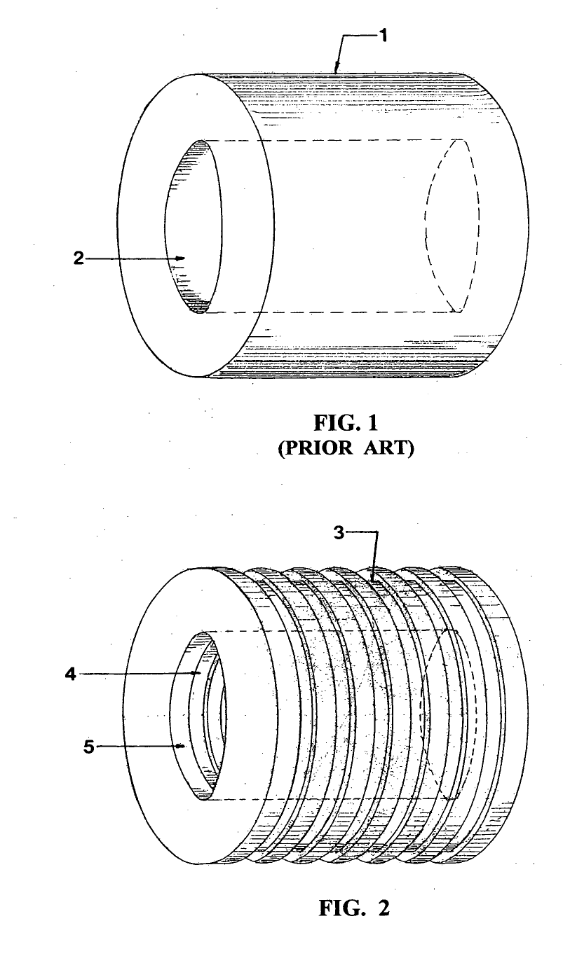

FIG. 2 is an isometric view of a non-compressed urethane spring in accordance with an embodiment of the invention wherein the exterior surface consists of equally spaced circular indentations 3 and comparably spaced indentations 4 within the inside surface of bore 5. The width and depth of the equally spaced concentric surface indentations 3 and corresponding bore's 5 indentations 4 would be based on design criteria such as the durometer of the urethane and the applied compressive load. Based on design criteria, when the urethane spring in FIG. 2 is in compression, bulging of the urethane spring will be eliminated or substantially minimized.

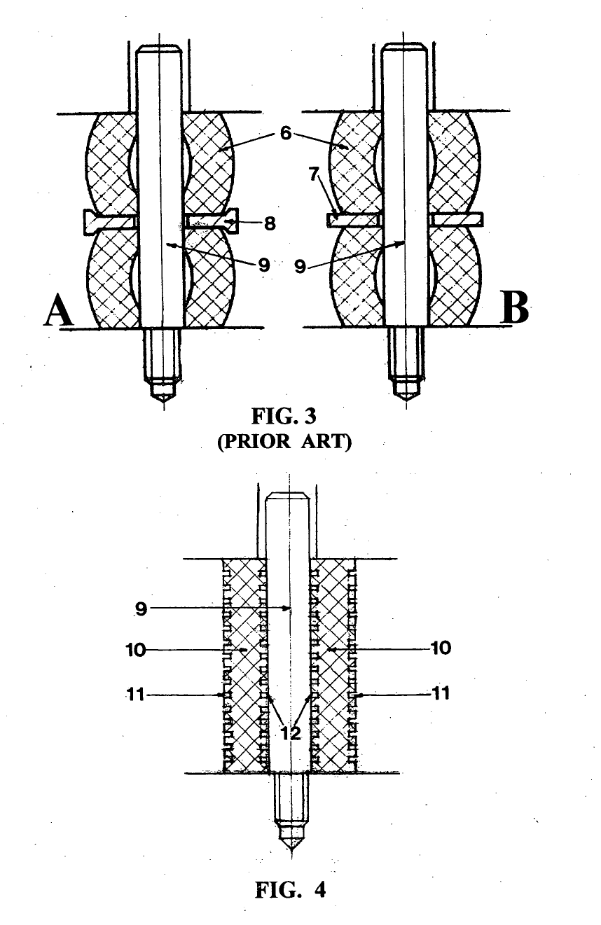

FIG. 3 is a standard prior art industry cross section detail, illustrating the recommended design protocol used in resolving the inherent problem of bulging when a urethane spring is compressed. The procedure is to stack short urethane spring sections and is explained in industry literature as follows: “The recommended maximum free (unloaded) length is two-and-one-half time's the spring out side diameter, although springs may be stacked with guide rods and washer-shaped spacers, for taller applications.”

Accordingly, two comparable industry detail examples are displayed, illustrating the recommended stacking procedure that minimizes bulging when urethane springs 6 are compressed . . . On the left side (ed. noted as “A”), short sections of urethane springs are stacked on guide pin 9 and each stacked spring 6 is separated from each other by a stacking dished washer 8. In the comparable stacking procedure on the right side (ed. noted as “B”), short spring sections of urethane 6 are stacked on guide pin 9 and separated from each other by a stacking flat washer 7. The two exampled details of stacked short sections of urethane compression springs 6 to minimize bulging, clearly illustrates that even using recommended solutions, the disadvantage of compression spring “bulging” is still very evident.

FIG. 4 is a cross section view in accordance with an embodiment of the invention of a urethane compression spring in a compressed state comparable in scale and configuration to the standard industry cross section example displayed in FIG. 3. Instead of the required two short stacked sections of urethane compression springs 6 to minimize bulging, one length of a urethane compression spring 10 is used with duplicate exterior indented concentric circles 11 equally spaced on center and the same indented concentric circles 12 equally spaced on center on the inside surface of the bore 5. As indicated, bulging as such would be eliminated or minimized.

In accordance with embodiments of the invention it would be assumed that these novel urethane compression springs would be pre-designed in classified groups of stock sizes inclusive of: diameters, depth and width of concentric circles; durometers; and, compressive loads.

While the invention has been particularly shown and described with reference to preferred embodiments thereof, it will be understood by those in the art that the foregoing and other form and details may be made therein without departing from the spirit and scope of the invention.

What is claimed is:

1. A urethane compression spring comprising:
a body having a periphery, a bore and
a plurality of indentations, at least in the periphery.

2. The spring of claim 1, wherein the periphery is cylindrical and the indentations are annular cutouts, having a certain depth and width.

3. The spring of claim 2, wherein the cutouts are in spaced relation in an axial direction.

4. The spring of claim 3, wherein the cut-outs are equally spaced.

5. The spring of claim 1, wherein a plurality of indentations are provided in a surface defining the bore.

6. The spring of claim 5, wherein the plurality of indentations in the bore surface are annular cutouts having a certain depth and width.

7. The spring of claim 6, wherein the annular cutouts in the bore surface are in spaced relation in an axial direction.
